(19) United States
(12) Patent Application Publication
(10) Pub. No.: US 2026/0178716 A1
(43) Pub. Date: Jun. 25, 2026

(54) MULTIPLE SENSOR PAIRING FOR ENHANCED DEVICE SECURITY

(71) Applicant: QUALCOMM Incorporated, San Diego, CA (US)

(72) Inventors: Jessica Liu STROHMANN, Cupertino, CA (US); Jae Hyeong SEO, Pleasanton, CA (US); Kostadin Dimitrov DJORDJEV, Los Gatos, CA (US)

(21) Appl. No.: 19/000,341

(22) Filed: Dec. 23, 2024

(51) Int. Cl. G06F 21/32; G06V 40/10; G06V 40/40

(52) U.S. Cl. CPC G06F 21/32; G06V 40/15; G06V 40/40

(57) ABSTRACT

Some methods may involve determining an authentication rule to authenticate a user of a device, wherein the authentication rule includes liveness criteria and authentication criteria. Some methods may involve determining satisfaction of the liveness criteria based on sensor data captured by one or more sensors of the device. Some methods may involve determining user interaction with one or more biometric sensors of the device in accordance with operation parameters specified by the authentication criteria. Some methods may involve, based on the user interaction in accordance with the operation parameters specified by the authentication criteria, providing biometric data obtained from the one or more biometric sensors for authentication.

### TECHNICAL FIELD

This disclosure relates generally to fingerprint sensors and other sensors used with displays, and methods, devices, and systems related to such sensors.

### DESCRIPTION OF THE RELATED TECHNOLOGY

Biometric authentication can be an important feature for controlling access to electronic devices, etc. Many existing products include fingerprint and other sensors for biometric authentication, gesture detection, and other functions. Although existing fingerprint sensors provide benefits, improved methods and devices would be desirable.

### SUMMARY

The systems, methods and devices of the disclosure each have several innovative aspects, no single one of which is solely responsible for the desirable attributes disclosed herein.

One innovative aspect of the subject matter described in this disclosure may be implemented via one or more methods. In some examples, a method may involve determining, by a control system, an authentication rule to authenticate a user of a device, wherein the authentication rule includes liveness criteria and authentication criteria. Some such methods involve determining, by the control system, satisfaction of the liveness criteria based on sensor data captured by one or more sensors of the device. Some such methods involve determining, by the control system, user interaction with one or more biometric sensors of the device in accordance with operation parameters specified by the authentication criteria. Some such methods involve based on the user interaction in accordance with the operation parameters specified by the authentication criteria, providing, by the control system, biometric data obtained from the one or more biometric sensors for authentication.

Other innovative aspects of the subject matter described in this disclosure may be implemented in an apparatus. The apparatus may include a user interface system that includes a display, a fingerprint sensor system, a memory system and a control system configured for communication with the display, the fingerprint sensor system and the memory system. The control system may include one or more general-purpose single-or multi-chip processors, digital signal processors (DSPs), application-specific integrated circuits (ASICs), field programmable gate arrays (FPGAs), or other programmable logic devices, discrete gates or transistor logic, discrete hardware components, or combinations thereof. In some implementations, a mobile device (such as a wearable device, a cellular telephone, etc.) may be, or may include, at least part of the apparatus.

According to some examples, the control system may be configured to determine an authentication rule to authenticate a user of the apparatus, wherein the authentication rule includes liveness criteria and authentication criteria. The control system may determine satisfaction of the liveness criteria based on sensor data captured by one or more sensors of the apparatus. The control system may determine user interaction with one or more biometric sensors of the apparatus in accordance with operation parameters specified by the authentication criteria. Based on the user interaction in accordance with the operation parameters specified by the authentication criteria, the control system may provide biometric data obtained from the one or more biometric sensors for authentication.

Some or all of the operations, functions and/or methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. Accordingly, some innovative aspects of the subject matter described in this disclosure can be implemented in one or more non-transitory media having software stored thereon.

For example, the software may include instructions for controlling one or more devices to perform one or more methods. Some such methods may involve determining, by a control system, an authentication rule to authenticate a user of a device, wherein the authentication rule includes liveness criteria and authentication criteria. Some such methods involve determining, by the control system, satisfaction of the liveness criteria based on sensor data captured by one or more sensors of the device. Some such methods involve determining, by the control system, user interaction with one or more biometric sensors of the device in accordance with operation parameters specified by the authentication criteria. Some such methods involve based on the user interaction in accordance with the operation parameters specified by the authentication criteria, providing, by the control system, biometric data obtained from the one or more biometric sensors for authentication.

### BRIEF DESCRIPTION OF THE DRAWINGS

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale. Like reference numbers and designations in the various drawings indicate like elements.

FIG. 1 is a block diagram that shows example components of an apparatus according to some disclosed implementations.

FIGS. 2A and 2B are illustrations of example electronic devices with foldable displays.

FIG. 3 is an illustration of an example foldable electronic device, according to some embodiments.

FIG. 4 is a flow diagram that provides example blocks of some methods disclosed herein.

FIG. 5 illustrates example authentication rules, according to some embodiments.

FIG. 6 illustrates an example application of an authentication rule, according to some embodiments.

FIG. 7 is a flow diagram that provides example blocks of some methods disclosed herein.

### DETAILED DESCRIPTION

The following description is directed to certain implementations for the purposes of describing the innovative aspects of this disclosure. However, a person having ordinary skill in the art will readily recognize that the teachings herein may be applied in a multitude of different ways. The described implementations may be implemented in any device, apparatus, or system that includes a biometric system as disclosed herein. In addition, it is contemplated that the described implementations may be included in or associated with a variety of electronic devices such as, but not limited to: mobile telephones, multimedia Internet enabled cellular telephones, mobile television receivers, wireless devices, smartphones, smart cards, wearable devices such as bracelets, armbands, wristbands, rings, headbands, patches, etc., Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), mobile health devices, computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, automatic teller machines (ATMs), parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also may be used in applications such as, but not limited to, electronic switching devices, radio frequency filters, sensors, accelerometers, gyroscopes, motion-sensing devices, magnetometers, inertial components for consumer electronics, parts of consumer electronics products, automobile doors, steering wheels or other automobile parts, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Identity spoofing represents a significant security vulnerability in biometric authentication systems. For example, fingerprint sensor systems, in particular, have experienced many successful spoofing efforts involving artificial fingerprints, which may be made using various readily available materials, such as gelatin, silicon, and latex. In such scenarios, latent fingerprints left on surfaces may be captured and used to create impressions that are then used to deceive fingerprint sensor systems. With artificial intelligence also being deployed to generate synthetic fingerprints, fingerprint sensor systems will likely continue experiencing fraudulent authentication attempts.

As used herein, the term “finger” can refer to any digit, including a thumb. Accordingly, the term “fingerprint” as used herein may refer to a print from any digit, including a thumb. Data received from a fingerprint sensor may sometimes be referred to herein as “fingerprint sensor data,” “fingerprint image data,” etc., although the data will generally be received from the fingerprint sensor system in the form of electrical signals. Accordingly, without additional processing such image data would not necessarily be perceivable as an image by a human being.

To combat such spoofing attempts, the approaches described herein enhance biometric authentication security by involving multiple sensors of a device in an authentication process. For example, in various embodiments, a device may implement one or more authentication rules that are evaluated when performing an authentication process. An authentication rule may specify liveness criteria and corresponding authentication criteria.

The liveness criteria may identify one or more events that must be detected when a user of the device is being authenticated. Satisfaction of the liveness criteria may be determined based at least in part on sensor data obtained from various sensors of the device.

The authentication criteria may define various operation parameters that govern which biometric sensors are used when authenticating a given user, an order in which the biometric sensors must be used, an amount of time a given biometric sensor should be activated (for example, by placing a finger on a fingerprint sensor), an amount of force to be applied when using the biometric sensors, or combinations thereof. For example, the authentication criteria may specify that a first fingerprint sensor must be activated simultaneously with a second fingerprint sensor, with greater force being applied to the second fingerprint sensor.

Particular implementations of the subject matter described in this disclosure may be implemented to realize one or more of the following potential advantages. As one example, using multiple sensors for liveness detection and biometric authentication may reduce spoofing efforts that would otherwise succeed with biometric authentication alone. In another example, deploying sensors to verify distinct aspects of liveness during authentication may help reduce false positives by cross-validating data across sensors. In yet another example, multi-sensor authentication may allow a device to more accurately distinguish between real and artificial fingerprints, making it more difficult for a fraudulent user to circumvent the authentication process with artificial inputs.

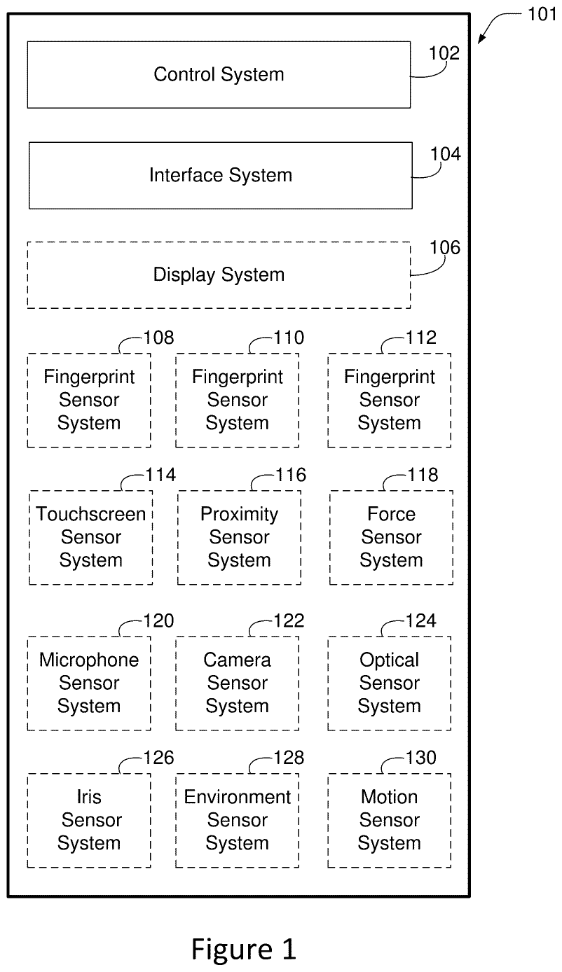

FIG. 1 is a block diagram that shows example components of an apparatus 101 according to some disclosed implementations. As with other disclosed implementations, the types, number and arrangement of elements shown in FIG. 1 are merely presented by way of example. Other implementations may have other types, numbers and/or arrangements of elements. In this example, the apparatus 101 includes a control system 102 and an interface system 104. Some implementations of the apparatus 101 may optionally include a display system 106, a fingerprint sensor system 108, a fingerprint sensor system 110, a fingerprint sensor system 112, a touchscreen sensor system 114, a proximity sensor system 116, a force sensor system 118, a microphone sensor system 120, a camera sensor system 122, an optical sensor system 124, an iris sensor system 126, an environment sensor system 128, a motion sensor system 130, or combinations thereof.

The fingerprint sensor system 108, the fingerprint sensor system 110, and the fingerprint sensor system 112 may implement any suitable type of fingerprint sensor system, such as an optical fingerprint sensor system, a capacitive fingerprint sensor system, a resistive fingerprint sensor system, a radio frequency-based fingerprint sensor system, etc. In some examples the fingerprint sensor system may be, or may include, an ultrasonic fingerprint sensor system.

Some implementations of the apparatus 101 may include an interface system 104. In some examples, the interface system 104 may include a wireless interface system. In some implementations, the interface system 104 may include one or more user interfaces, one or more network interfaces, one or more interfaces between the control system 102 and a memory system, and/or one or more interfaces between the control system 102 and one or more external device interfaces (e.g., ports or applications processors).

The interface system 104 may be configured to provide communication (which may include wired or wireless communication, such as electrical communication, radio communication, etc.) between components of the apparatus 101. In some such examples, the interface system 104 may be configured to provide communication between the control system 102 and the fingerprint sensor system 108, between the control system 102 and the fingerprint sensor system 110, between the control system 102 and the fingerprint sensor system 112, and between the control system 102 and the display system 106 (if present). Depending on the implementation, the interface system 104 may be configured to provide communication between the control system 102 and the touchscreen sensor system 114, between the control system 102 and the proximity sensor system 116, between the control system 102 and the force sensor system 118, between the control system 102 and the microphone sensor system 120, between the control system 102 and the camera sensor system 122, between the control system 102 and the optical sensor system 124, between the control system 102 and the iris sensor system 126, between the control system 102 and the environment sensor system 128, and between the control system 102 and the motion sensor system 130.

According to some such examples, the interface system 104 may couple at least a portion of the control system 102 to the fingerprint sensor system 108, to the fingerprint sensor system 110, and to the fingerprint sensor system 112, as well as the display system 106, if present (e.g., via electrically conducting material such as conductive metal wires or traces). Similarly, depending on the implementation, the interface system 104 may couple at least a portion of the control system 102 to the touchscreen sensor system 114, to the proximity sensor system 116, to the force sensor system 118, to the microphone sensor system 120, to the camera sensor system 122, to the optical sensor system 124, to the iris sensor system 126, to the environment sensor system 128, and to the motion sensor system 130 (e.g., via electrically conducting material such as conductive metal wires or traces).

According to some examples, the interface system 104 may be configured to provide communication between the apparatus 101 and other devices and/or human beings. In some such examples, the interface system 104 may include a user interface system having one or more user interfaces. The user interface system may, for example, include one or more loudspeakers, a touch and/or gesture sensor system, a haptic feedback system, etc. Although not shown as such in FIG. 1, the optional display system 106 may be considered to be part of the interface system 104.

The interface system 104 may, in some examples, include one or more graphical user interfaces (GUIs). The interface system 104 may, in some examples, include one or more network interfaces and/or one or more external device interfaces (such as one or more universal serial bus (USB) interfaces and/or a serial peripheral interface (SPI)).

In some implementations, the apparatus 101 may include a memory system in addition to memory that the control system 102 may include. The interface system 104 may, in some examples, include at least one interface between the control system 102 and the memory system.

The control system 102 may include one or more general purpose single-or multi-chip processors, digital signal processors (DSPs), application specific integrated circuits (ASICs), field programmable gate arrays (FPGAs) or other programmable logic devices, discrete gates or transistor logic, discrete hardware components, or combinations thereof. According to some examples, the control system 102 may include dedicated components for controlling the fingerprint sensor system 108, the fingerprint sensor system 110, and the fingerprint sensor system 112 (as well as the display system 106, if present). Depending on the implementation, the control system 102 may include dedicated components for controlling the touchscreen sensor system 114, the proximity sensor system 116, the force sensor system 118, the microphone sensor system 120, the camera sensor system 122, the optical sensor system 124, the iris sensor system 126, the environment sensor system 128, and to motion sensor system 130.

The control system 102 also may include (and/or be configured for communication with) one or more memory devices, such as one or more random access memory (RAM) devices, read-only memory (ROM) devices, etc. Accordingly, the apparatus 101 may have a memory system that includes one or more memory devices, though the memory system is not shown in FIG. 1. In some implementations, functionality of the control system 102 may be partitioned between one or more controllers or processors, such as between a dedicated sensor controller and an applications processor of a mobile device. In some implementations, an application processor may have a dedicated coprocessor and/or software modules for secure processing of biometric sensor data within the application processor (sometimes referred to as the “trust zone”).

In some implementations, the apparatus 101 may include a single controller chip to control a plurality of fingerprint sensors, as described in U.S. patent application Ser. No. 18/789,113 entitled “Multiple Sensor Pairing with Single Controller for Display Applications,” the entirety of which is incorporated by reference herein. According to some embodiments, for example, a single controller chip may be included on a flexible substrate (e.g., a flexible printed circuit (FPC)) with two or more fingerprint sensors, where the flexible substrate enables each of the two or more fingerprint sensors to be used with a different respective display or a different respective planar portion of a foldable display. In the latter case, for example, the flexible substrate may bridge one or more folds of the foldable display, allowing for fingerprint sensors (driven by a single controller chip) to be included on different sides of the one or more folds. According to some embodiments, a set of one or more flexible substrates may be used, where the flexible substrates are electronically coupled using one or more connectors. For example, a first fingerprint sensor and the controller chip may be mounted on a first flexible substrate, and a second fingerprint sensor may be mounted on a second flexible substrate that is electronically coupled with the first flexible substrate via an electronic connector. Such embodiments may further include a memory (e.g., an erasable programmable read-only memory (EPROM)) mounted on the second flexible substrate and configured to store tuning information for the second fingerprint sensor. According to some embodiments, this tuning information may be related to the controller chip via an application processor (e.g., to which the set of one or more flexible substrates is electrically connected).

The apparatus 101 may be used in a variety of different contexts, some examples of which are disclosed herein. For example, in some implementations a mobile device may include at least a portion of the apparatus 101. In some implementations, a wearable device may include at least a portion of the apparatus 101. The wearable device may, for example, be a bracelet, an armband, a wristband, a ring, a headband or a patch. In some implementations, the control system 102 may reside in more than one device. For example, a portion of the control system 102 may reside in a wearable device and another portion of the control system 102 may reside in another device, such as a mobile device (e.g., a smartphone). The interface system 104 also may, in some such examples, reside in more than one device.

It can be noted that embodiments described herein focused primarily on fingerprint sensors used in foldable displays. However, embodiments are not so limited. Specifically, some embodiments may use traditional (non-foldable) displays, other types of display-based sensors (in addition or as an alternative to fingerprint sensors), sensors utilizing different technologies (e.g., ultrasonic, capacitive, optical, etc.), or any combination thereof. Some embodiments may use sensors that are capable of sensing multiple types of sensing. For example, some multifunction (e.g., ultrasonic) sensors may be capable of sensing fingerprints, since stylus input, gesture recognition, etc.

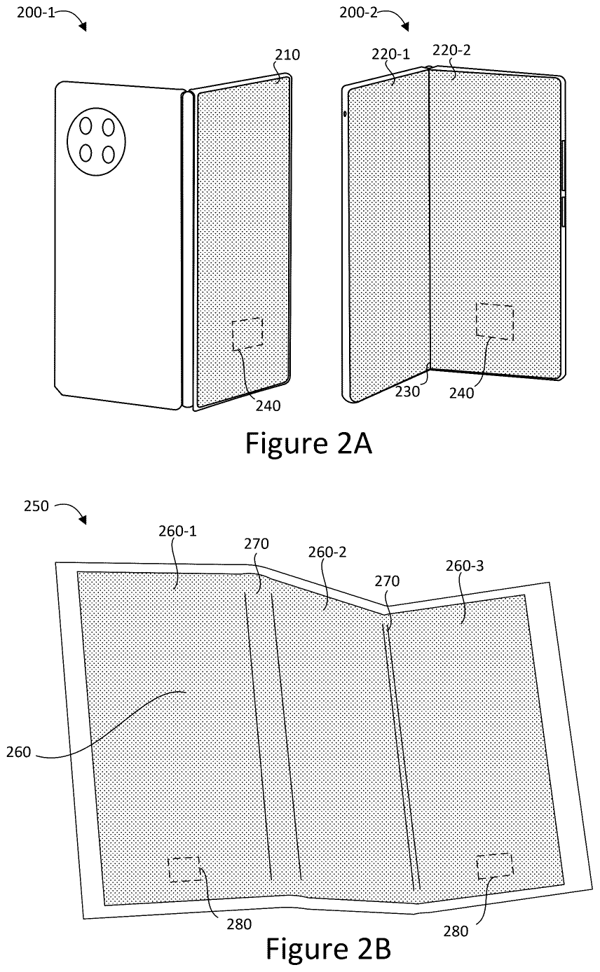

FIGS. 2A and 2B are illustrations of example electronic devices with foldable displays. According to some embodiments, the electronic devices may be implementations of the apparatus 101.

FIG. 2A illustrates a perspective view of an outside 200-1 and inside 200-2 of a first example electronic device (e.g., mobile phone) that may utilize multiple fingerprint sensors. In this example, the device includes an outside display 210, and a foldable inner display with two portions 220-1 and 220-2 separated by a fold 230. The inner display, which includes both portions 220-1 and 220-2 is referred to herein as inner display 220. Foldable displays of electronic devices, such as inner display 220, are often divided into planar sections (e.g., portions 220-1 and 220-2), as illustrated in FIG. 2A. Fingerprint sensors can be embedded in or behind displays (also referred to herein as “below-display” or “under-display” sensors) at certain locations, as indicated by boxes 240. As with other figures appended hereto, the types, numbers and arrangements of elements that are shown in FIG. 2A are merely presented by way of example. Other examples may include different types of elements, numbers of elements, arrangements of elements, or combinations thereof.

FIG. 2B is an illustration of a perspective view of another type of electronic device 250 that may utilize multiple fingerprint sensors. In this example, the device has a display 260 with three portions 260-1, 260-2, and 260-3, which are separated by folds 270. Fingerprint sensors are located within the display 260, as illustrated by boxes 280.

According to some examples, the fingerprint sensors such as those illustrated in FIGS. 2A and 2B may be, or may include, layers of a fingerprint sensor, which may be flexible. Alternatively, or additionally, in some implementations, the fingerprint sensors may be, or may include, any type of flexible fingerprint sensor, such as a flexible ultrasonic fingerprint sensor, a flexible optical fingerprint sensor, a flexible capacitive fingerprint sensor, etc.

Data received from fingerprint sensors may sometimes be referred to herein as “fingerprint sensor data,” “fingerprint sensor signals,” “fingerprint image data,” etc., whether or not the received data corresponds to an actual digit or another object. Such data will generally be received from the fingerprint sensor in the form of electrical signals. Accordingly, without additional processing such image data would not necessarily be perceivable by a human being as an image.

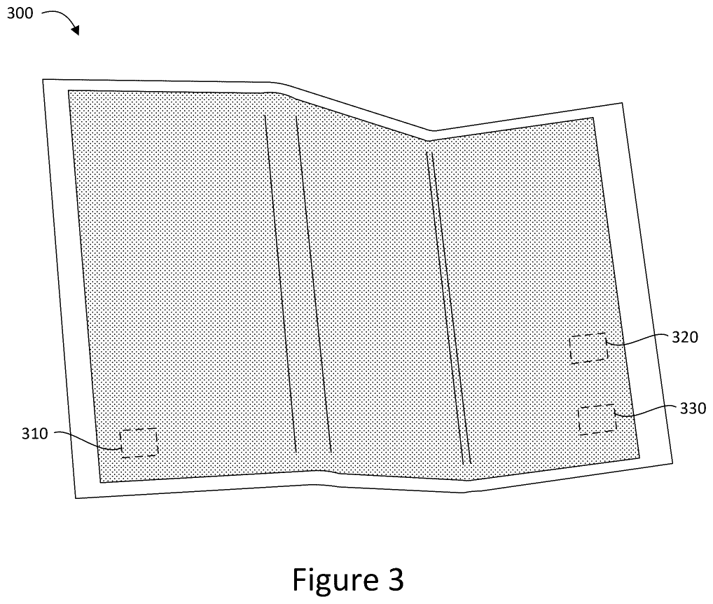

FIG. 3 is an illustration of an example foldable electronic device 300. The electronic device 300 may be one implementation of the apparatus 101. In this example, fingerprint sensors are located at a first location 310, a second location 320, and a third location 330. According to some embodiments, fingerprint sensors at these locations 310, 320, and 330 may be operated to increase security beyond fingerprint sensing based on application of authentication rules, as described herein. For example, an authentication rule may require satisfaction of liveness criteria and authentication criteria. The liveness criteria may be evaluated based on sensor data captured by sensors of foldable electronic device 300. The authentication criteria may include operation parameters that govern sensor usage, as described herein. As an example, to enroll in fingerprint sensing and/or pass a security screening (e.g., to unlock a device, open an application, etc.), authentication criteria may require a user to first place a finger at the first location 310, then place a finger (the same finger or a different (e.g., preselected) finger) at the second location 320, then place a finger (again, the same or different finger) at the third location 330. In another example, authentication criteria may require a user to place fingers at all three locations 310, 320, and 330 simultaneously. In yet another example, to enroll and/or authenticate using fingerprints, authentication criteria may require a user to place a first finger on a first location 310, place a second finger on a second location 320, or simultaneously place first and second fingers on the first and second locations 310 and 320, respectively. Additionally or alternatively, authentication criteria may require a user to place fingers at second location 320 and third location 330 with regular force, but place a finger at first location 310 with heavy force (e.g., above a certain threshold amount of force, detectable by the fingerprint sensor at first location 310).

In some embodiments, fingerprint (or multifunction) sensors at locations 310, 320, and 330 may be controlled by the same controller, or may be controlled by (e.g., two or three) different controllers, as described in U.S. patent application Ser. No. 18/789,113 entitled “Multiple Sensor Pairing with Single Controller for Display Applications,” the entirety of which is incorporated by reference herein.

By coupling multiple fingerprint sensors to a single controller in the manner described herein, data from multiple fingerprint sensors can be processed directly on the controller chip, rather than stored in a separate memory of the device. This can reduce latency and also reduce the risk of data leakage, increasing security. Further, because fingerprint information obtained by the multiple fingerprint sensors can be stored by the controller, fingerprint information obtained by one sensor may be subsequently used at other locations. For example, in FIG. 3, a user may scan a thumbprint at location 310 for subsequent authentication, then subsequently perform authentication by scanning the thumbprint at location 320 and/or 330. Again, because this thumbprint data may be stored by the controller, the risk of unauthorized access to the thumbprint data is reduced. Information provided by the controller to the application processor and/or memory of the electronic device 300 may be limited to a confirmation that fingerprint authentication was successful, rather than the transfer of any fingerprint data.

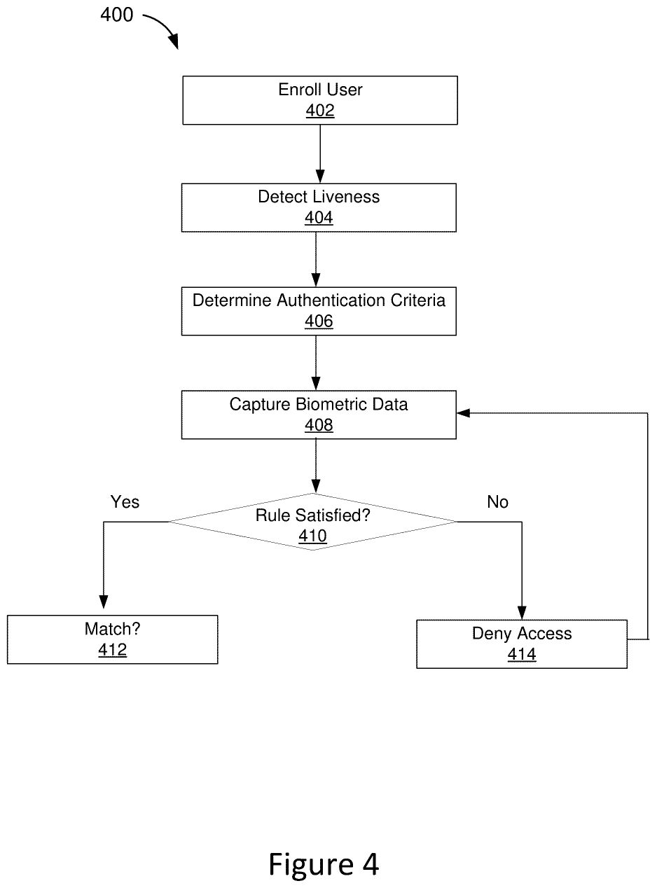

FIG. 4 is a flow diagram that provides example blocks of some methods disclosed herein. The blocks of FIG. 4 may, for example, be performed (at least in part) by the control system 102 of FIG. 1. As with other methods disclosed herein, the method 400 outlined in FIG. 4 may include more or fewer blocks than indicated. Moreover, the blocks of methods disclosed herein are not necessarily performed in the order indicated. In some examples, some blocks of methods disclosed herein may be performed concurrently or substantially concurrently.

In this example, the method 400 optionally begins with block 402. Block 402 may, for example, involve enrolling a user of the foldable display device. The enrollment process may involve the user placing their finger multiple times on one or more fingerprint sensor systems. In some implementations, the enrollment process is performed using the fingerprint sensor system 108, the fingerprint sensor system 110, the fingerprint sensor system 112, or combinations thereof. The fingerprint sensor system may capture a high-resolution image of a fingerprint of the user each time. These images may then be processed to extract the unique features and patterns of the fingerprint, such as the ridges, valleys, and minutiae points. The extracted features may be used to create a mathematical representation of the fingerprint (e.g., a fingerprint template), which is securely stored in memory on the foldable display device. During the enrollment phase, the user may be prompted to place their finger at slightly different angles or positions each time, allowing the system to capture a comprehensive map of the finger. Once the enrollment is complete, the stored fingerprint template may be used as a reference for comparison during future authentication attempts. In some implementations, the enrollment process may be adaptive. That is, once the user is initially enrolled, the adaptive enrollment process may involve continually refining the fingerprint template associated with the user with fingerprint image data that is captured during subsequent authentication attempts.

In this example, block 404 involves detecting liveness based on liveness criteria associated with authentication rules. In various embodiments, an authentication rule may specify liveness criteria and corresponding authentication criteria. The liveness criteria may identify one or more events (e.g., gesture detection, voice detection, face detection, etc.) to be satisfied individually or in combination when authenticating a user of the device. Such events may provide some assurance that a human being is present at the time of authentication. Accordingly, the liveness criteria may enhance security by addressing vulnerabilities like spoofing and other fraudulent activities. Such liveness detection helps ensure that the biometric data being presented originates from a live human rather than a fake representation, such as a fingerprint mold or a high-resolution replica.

Authentication rules to be applied may be selected randomly or dynamically. For example, in some embodiments, sensor data from one or more sensors of a device may be evaluated dynamically to determine whether liveness criteria associated with a given authentication rule is satisfied. If liveness criteria associated with an authentication rule is determined to be satisfied, authentication criteria associated with that authentication rule may be applied.

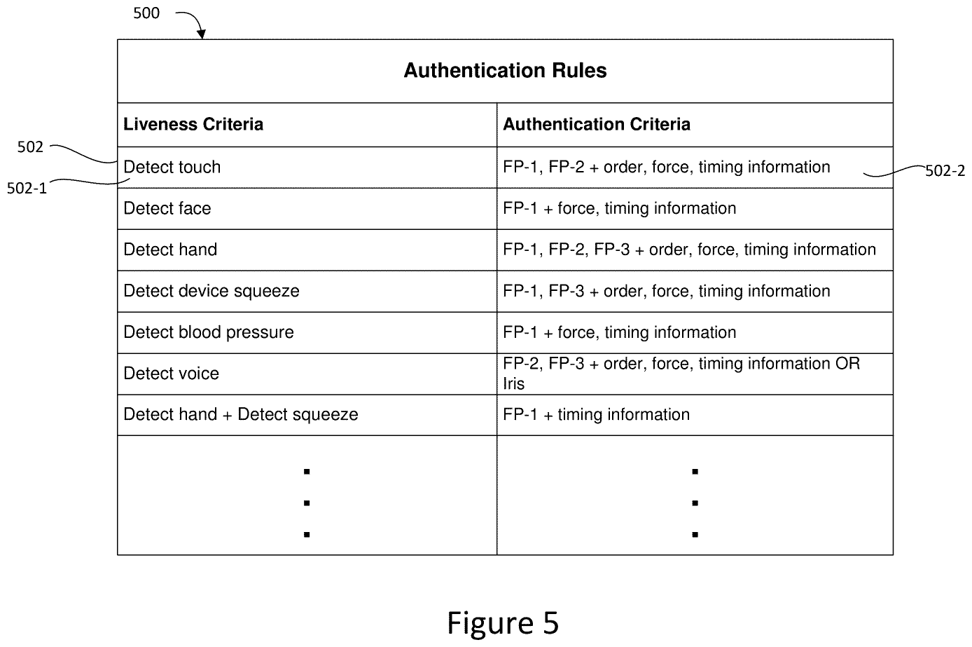

For example, FIG. 5 illustrates an example set of authentication rules 500 that may be stored in memory. As illustrated in FIG. 5, an example authentication rule 502 may be associated with liveness criteria 502-1 that is satisfied upon detecting a touch gesture event.

There may be any number of events that may be specified as liveness criteria depending on the implementation and security requirements. In some embodiments, liveness criteria may include a touch gesture detection event that is satisfied upon detecting a touch against a display screen of the device. For example, the touch gesture detection event may be detected by the touchscreen sensor system 114, which may implement capacitive touchscreen technology capable of detecting finger touches.

According to some embodiments, liveness criteria may include a hand gesture detection event that is satisfied upon detecting a hand near the device. For example, the hand gesture detection event may be detected by the proximity sensor system 116, which may implement infrared (IR) technology to detect nearby objects without physical contact with the device.

In some embodiments, liveness criteria may include a squeeze gesture detection event that is satisfied upon detecting a hand squeezing the device. For example, the squeeze gesture detection event may be detected by the force sensor system 118, which may implement technology to detect intentional squeezes of the device. For example, the force sensor system 118 may implement the strain gauge method, barometric pressure method, or ultrasound detection to detect squeezes.

In some embodiments, liveness criteria may include a voice detection event that is satisfied upon detecting a human voice. For example, the voice detection event may be detected by the microphone sensor system 120, which may implement technology to convert sound waves into electrical signals and audio processing technology to detect human voice based on extracted features, such as pitch, tone, and frequency patterns.

In some embodiments, liveness criteria may include a face detection event that is satisfied upon detecting a human face. For example, the face detection event may be detected by the camera sensor system 122, which may implement an infrared projector, a flood illuminator, and camera(s) that capture facial patterns. The camera sensor system 122 may also implement technology to process the captured facial patterns to determine when a human face is near the device.

In some embodiments, liveness criteria may include a blood pressure (BP) detection event that is satisfied upon detecting blood pressure from a finger. For example, the BP detection event may be detected by the optical sensor system 124, which may implement a light-emitting diode (LED) that emits near-infrared light into the skin, a photosensitive detector that measures reflected light, and technology to detect changes in blood volume through light absorption patterns. For example, the optical sensor system 124 may shine light beams into the skin, measure variations in light reflection as blood vessels expand and contract, and detect changes in blood flow volume during each heartbeat. In some embodiments, BP sensing capability may be integrated into a fingerprint sensor so that BP may be detected during a fingerprint scan. In some embodiments, BP may be detected based on fingerprint image data captured by a fingerprint sensor.

In some embodiments, liveness criteria may be omitted entirely and user authentication may be achieved based on satisfaction of authentication criteria alone.

In this example, block 406 involves determining authentication criteria to be satisfied. As mentioned, authentication rules may be associated with both liveness criteria and authentication criteria. For example, authentication criteria may require use of one or more specified biometric sensors through which the user may provide biometric information for authentication purposes, such as one or more fingerprint sensors.

According to some embodiments, authentication criteria may require operation (or activation) of one or more fingerprint sensors (e.g., the fingerprint sensor 108 at location 310, the fingerprint sensor 110 at location 320, the fingerprint sensor 112 at location 330). Depending on the implementation, when multiple fingerprint sensors are required, the authentication criteria may require the same finger or different fingers be used to operate a given fingerprint sensor. Many variations are possible.

In the foregoing example, FIG. 5 illustrates example authentication criteria 502-2 associated with the authentication rule 502. In this example, the authentication criteria 502-2 that requires use of a first fingerprint sensor (“FP-1”) and a second fingerprint sensor (“FP-2”) to provide biometric data for authentication purposes. In various embodiments, authentication criteria may specify operation parameters, such as a specified order in which sensors should be operated (or activated), an amount of force to be applied, or an amount of activation time, as described herein. In the foregoing example, the authentication criteria 502-2 may require the user to authenticate using the first fingerprint sensor (“FP-1”) followed by the second fingerprint sensor (“FP-2”).

According to some embodiments, authentication criteria may additionally or alternatively require a user to apply some amount of finger force on one or more fingerprint sensors. For example, the authentication criteria may require the user to place a finger on two fingerprint sensors (e.g., location 320, location 330) with regular force, but place a finger on a third fingerprint sensor (e.g., location 310) with heavy force (e.g., above a certain threshold amount of force).

According to some embodiments, authentication criteria may additionally or alternatively require a user to place a finger on one or more fingerprint sensors for some amount of time. For example, the authentication criteria may require the user to simultaneously place a finger on a first fingerprint sensor (e.g., location 310) and a finger on a second fingerprint sensor (e.g., location 330) for five seconds. Many variations are possible.

In this example, block 408 involves capturing biometric data from the biometric sensors. For example, fingerprint image data may be captured from one or more fingerprint sensors based on user interaction, such as the user placing their finger(s) on the one or more fingerprint sensors.

In this example, block 410 involves determining whether the authentication rule is satisfied. For example, in some embodiments, the authentication rule may be determined to be satisfied when both liveness criteria and authentication criteria associated with the authentication rule are satisfied.

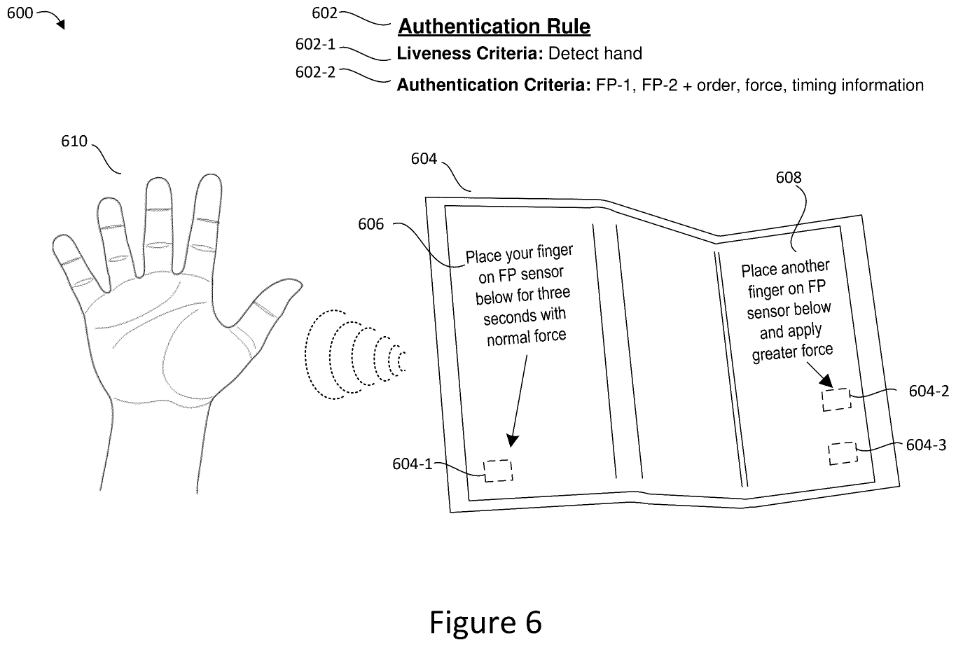

For example, FIG. 6 illustrates an example application 600 of an authentication rule 602, according to some embodiments. In this example, the authentication rule 602 includes liveness criteria 602-1 and authentication criteria 602-2. In various embodiments, the authentication rule 602 may be satisfied when both the liveness criteria 602-1 and the authentication criteria 602-2 are satisfied. In this example, the liveness criteria 602-1 may be satisfied when a device 604 detects a hand 610, for example, using a proximity sensor. Further, the authentication criteria 602-2 may be satisfied when a user places a finger on a first fingerprint sensor 604-1 for three seconds with normal force and another finger on a second fingerprint sensor 604-2 with greater force.

In various embodiments, liveness criteria and authentication criteria associated with an authentication rule may be satisfied independently and in any order. For example, in some embodiments, an authentication rule may require liveness criteria to be satisfied before authentication criteria are evaluated. In such embodiments, any attempts to satisfy the authentication criteria will fail if the liveness criteria is not first satisfied. Alternatively, in some embodiments, an authentication rule may be satisfied when authentication criteria is satisfied before liveness criteria is satisfied.

In various embodiments, instructions for guiding a user to complete the authentication criteria 602-2 may be provided, for example, in graphical user interfaces (GUIs) provided via one or more display screens of the device 604. In the example of FIG. 6, the device 604 provides instructions 606 that guide the user to place a finger on the first fingerprint sensor 604-1 for three seconds with normal force and instructions 608 that guide the user to place a finger on the second fingerprint sensor 604-2 with greater force.

In this example, if it is determined in block 410 that the authentication rule is satisfied, method 400 may proceed to block 412, which may involve matching the biometric data based on a matching process. For example, the matching process may involve analyzing fingerprint image data captured by one or more fingerprint sensors to extract unique fingerprint features, such as the pattern of ridges, valleys, and minutiae points. The extracted features may be converted into a mathematical representation of the fingerprint image data (e.g., a fingerprint template). The template of the fingerprint image data may then be compared against enrolled fingerprint template(s) already stored in memory. The comparison may involve calculating a degree of similarity (or similarity score) between the template of the fingerprint image data and the enrolled fingerprint template(s), to determine if there is a match. The matching may be performed by measuring the distances and relative positions of specific fingerprint features. In this example, if the similarity score satisfies a predefined threshold, the match is successful, and the user is authenticated. For example, upon authentication, the apparatus may be “unlocked” (e.g., the user is granted access to the apparatus or one or more software applications running on the apparatus). In contrast, if the score fails to satisfy the threshold, the match is unsuccessful, and the user may be prompted to try again or use an alternate authentication method.

In this example, if it is determined in block 410 that the authentication rule is not satisfied, method 400 may proceed to block 414, where the user is denied access. In some embodiments, the user may be instructed to attempt authentication again.

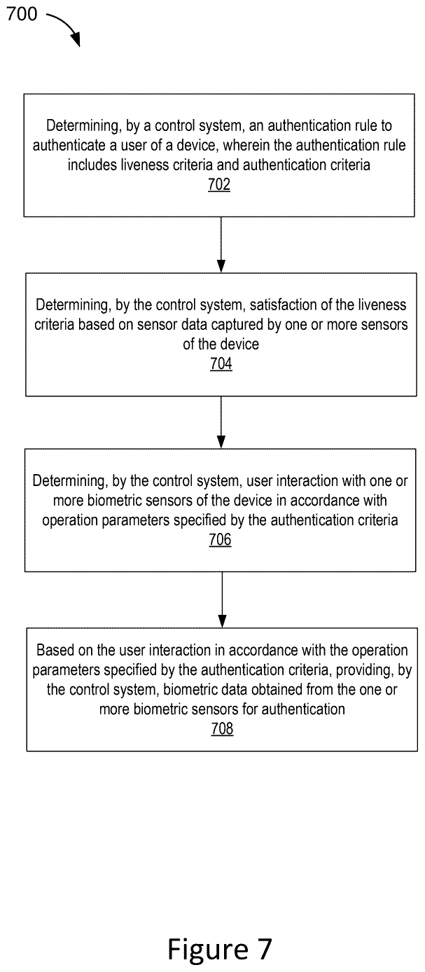

FIG. 7 is a flow diagram that provides example blocks of some methods disclosed herein. The blocks may, for example, be performed by the apparatus 101, or by a similar apparatus. As with other methods disclosed herein, the method 700 outlined in FIG. 7 may include more or fewer blocks than indicated. Moreover, the blocks of methods disclosed herein are not necessarily performed in the order indicated. In some examples, some blocks of methods disclosed herein may be performed concurrently or substantially concurrently.

According to this example, the method 700 is a method of processing biometric data. In this example, block 702 involves determining, by a control system (such as the control system 102), an authentication rule (such as the authentication rule 502) to authenticate a user of a device (such as the foldable electronic device 300), wherein the authentication rule includes liveness criteria and authentication criteria.

In this example, block 704 involves determining, by the control system, satisfaction of the liveness criteria based on sensor data captured by one or more sensors of the device, as described herein.

In this example, block 706 involves determining, by the control system, user interaction with one or more biometric sensors of the device in accordance with operation parameters specified by the authentication criteria, as described herein.

In this example, block 708 involves, based on the user interaction in accordance with the operation parameters specified by the authentication criteria, providing, by the control system, biometric data obtained from the one or more biometric sensors for authentication.

According to some examples, determining satisfaction of the liveness criteria based on sensor data captured by the one or more sensors of the device includes detecting a touch gesture, hand gesture, squeeze gesture, voice, face, blood pressure (BP), button activation, or combinations thereof. In some examples, the control system provides user instructions requesting the biometric data based at least in part on the operation parameters specified by the authentication criteria. In some examples, the user instructions provide an order in which the one or more biometric sensors should be activated, an amount of force to be applied to the one or more biometric sensors, an amount of time the one or more biometric sensors should be activated, or combinations thereof.

According to some examples, the operation parameters specified by the authentication criteria require user authentication using a first fingerprint sensor of the device, a second fingerprint sensor of the device, a third fingerprint sensor of the device, an iris sensor, or combinations thereof. In some examples, at least two of the first fingerprint sensor, the second fingerprint sensor, and the third fingerprint sensor are connected to a same controller of the device.

According to some examples, the operation parameters specified by the authentication criteria require simultaneous operation of at least two of the first fingerprint sensor of the device, the second fingerprint sensor of the device, or the third fingerprint sensor of the device during the user authentication. According to some examples, the operation parameters specified by the authentication criteria define a sequential order for operating at least two of the first fingerprint sensor of the device, the second fingerprint sensor of the device, or the third fingerprint sensor of the device during the user authentication. According to some examples, the operation parameters specified by the authentication criteria define an amount of finger force to be applied when operating at least one of the first fingerprint sensor of the device, the second fingerprint sensor of the device, or the third fingerprint sensor of the device during the user authentication. According to some examples, the operation parameters specified by the authentication criteria define an amount of time a finger should be placed on at least one of the first fingerprint sensor of the device, the second fingerprint sensor of the device, or the third fingerprint sensor of the device during the user authentication.

Implementation examples are described in the following numbered clauses:
1. A method of processing biometric data, the method comprising: determining, by a control system, an authentication rule to authenticate a user of a device, wherein the authentication rule includes liveness criteria and authentication criteria; determining, by the control system, satisfaction of the liveness criteria based on sensor data captured by one or more sensors of the device; determining, by the control system, user interaction with one or more biometric sensors of the device in accordance with operation parameters specified by the authentication criteria; and based on the user interaction in accordance with the operation parameters specified by the authentication criteria, providing, by the control system, biometric data obtained from the one or more biometric sensors for authentication.
2. The method of clause 1, wherein determining satisfaction of the liveness criteria based on sensor data captured by the one or more sensors of the device includes detecting a touch gesture, hand gesture, squeeze gesture, voice, face, blood pressure (BP), button activation, or combinations thereof.
3. The method of clause 1 or clause 2, further comprising: providing, by the control system, user instructions requesting the biometric data based at least in part on the operation parameters specified by the authentication criteria.
4. The method of clauses 1-3, wherein the user instructions provide an order in which the one or more biometric sensors should be activated, an amount of force to be applied to the one or more biometric sensors, an amount of time the one or more biometric sensors should be activated, or combinations thereof.
5. The method of clauses 1-4, wherein the operation parameters specified by the authentication criteria require user authentication using a first fingerprint sensor of the device, a second fingerprint sensor of the device, a third fingerprint sensor of the device, an iris sensor, or combinations thereof.
6. The method of clause 5, wherein at least two of the first fingerprint sensor, the second fingerprint sensor, and the third fingerprint sensor are connected to a same controller of the device.
7. The method of clause 5, wherein the operation parameters specified by the authentication criteria require simultaneous operation of at least two of the first fingerprint sensor of the device, the second fingerprint sensor of the device, or the third fingerprint sensor of the device during the user authentication.
8. The method of clause 5, wherein the operation parameters specified by the authentication criteria define a sequential order for operating at least two of the first fingerprint sensor of the device, the second fingerprint sensor of the device, or the third fingerprint sensor of the device during the user authentication.
9. The method of clause 5, wherein the operation parameters specified by the authentication criteria define an amount of finger force to be applied when operating at least one of the first fingerprint sensor of the device, the second fingerprint sensor of the device, or the third fingerprint sensor of the device during the user authentication.
10. The method of clause 5, wherein the operation parameters specified by the authentication criteria define an amount of time a finger should be placed on at least one of the first fingerprint sensor of the device, the second fingerprint sensor of the device, or the third fingerprint sensor of the device during the user authentication.
11. An apparatus, comprising: a control system configured to: determine an authentication rule to authenticate a user of the apparatus, wherein the authentication rule includes liveness criteria and authentication criteria; determine satisfaction of the liveness criteria based on sensor data captured by one or more sensors of the apparatus; determine user interaction with one or more biometric sensors of the apparatus in accordance with operation parameters specified by the authentication criteria; and based on the user interaction in accordance with the operation parameters specified by the authentication criteria, provide biometric data obtained from the one or more biometric sensors for authentication.
12. The apparatus of clause 11, wherein determining satisfaction of the liveness criteria based on sensor data captured by the one or more sensors of the apparatus includes detecting a touch gesture, hand gesture, squeeze gesture, voice, face, blood pressure (BP), button activation, or combinations thereof.
13. The apparatus of clause 11 or clause 12, wherein the control system is configured to: provide user instructions requesting the biometric data based at least in part on the operation parameters specified by the authentication criteria.
14. The apparatus of clauses 11-13, wherein the user instructions provide an order in which the one or more biometric sensors should be activated, an amount of force to be applied to the one or more biometric sensors, an amount of time the one or more biometric sensors should be activated, or combinations thereof.
15. The apparatus of clauses 11-14, wherein the operation parameters specified by the authentication criteria require user authentication using a first fingerprint sensor of the device, a second fingerprint sensor of the device, a third fingerprint sensor of the device, an iris sensor, or combinations thereof.
16. One or more non-transitory computer-readable media having instructions for performing a method stored thereon, the method comprising: determining, by a control system, an authentication rule to authenticate a user of a device, wherein the authentication rule includes liveness criteria and authentication criteria; determining, by the control system, satisfaction of the liveness criteria based on sensor data captured by one or more sensors of the device; determining, by the control system, user interaction with one or more biometric sensors of the device in accordance with operation parameters specified by the authentication criteria; and based on the user interaction in accordance with the operation parameters specified by the authentication criteria, providing, by the control system, biometric data obtained from the one or more biometric sensors for authentication.
17. The one or more non-transitory computer-readable media of clause 16, wherein determining satisfaction of the liveness criteria based on sensor data captured by the one or more sensors of the device includes detecting a touch gesture, hand gesture, squeeze gesture, voice, face, blood pressure (BP), button activation, or combinations thereof.
18. The one or more non-transitory computer-readable media of clauses 16 or 17, further comprising: providing, by the control system, user instructions requesting the biometric data based at least in part on the operation parameters specified by the authentication criteria.
19. The one or more non-transitory computer-readable media of clauses 16-18, wherein the user instructions provide an order in which the one or more biometric sensors should be activated, an amount of force to be applied to the one or more biometric sensors, an amount of time the one or more biometric sensors should be activated, or combinations thereof.
20. The one or more non-transitory computer-readable media of clauses 16-19, wherein the operation parameters specified by the authentication criteria require user authentication using a first fingerprint sensor of the device, a second fingerprint sensor of the device, a third fingerprint sensor of the device, an iris sensor, or combinations thereof.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium, such as a non-transitory medium. The processes of a method or algorithm disclosed herein may be implemented in a processor-executable software module which may reside on a computer-readable medium. Computer-readable media include both computer storage media and communication media including any medium that may be enabled to transfer a computer program from one place to another. Storage media may be any available media that may be accessed by a computer. By way of example, and not limitation, non-transitory media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those having ordinary skill in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein, if at all, to mean “serving as an example, instance, or illustration.” Any implementation described herein as “exemplary” is not necessarily to be construed as preferred or advantageous over other implementations.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, other implementations are within the scope of the following claims. In some cases, the actions recited in the claims may be performed in a different order and still achieve desirable results.

It will be understood that unless features in any of the particular described implementations are expressly identified as incompatible with one another or the surrounding context implies that they are mutually exclusive and not readily combinable in a complementary and/or supportive sense, the totality of this disclosure contemplates and envisions that specific features of those complementary implementations may be selectively combined to provide one or more comprehensive, but slightly different, technical solutions. It will therefore be further appreciated that the above description has been given by way of example only and that modifications in detail may be made within the scope of this disclosure.

What is claimed is:

1. A method of processing biometric data, the method comprising:
determining, by a control system, an authentication rule to authenticate a user of a device, wherein the authentication rule includes liveness criteria and authentication criteria;
determining, by the control system, satisfaction of the liveness criteria based on sensor data captured by one or more sensors of the device;
determining, by the control system, user interaction with one or more biometric sensors of the device in accordance with operation parameters specified by the authentication criteria; and
based on the user interaction in accordance with the operation parameters specified by the authentication criteria, providing, by the control system, biometric data obtained from the one or more biometric sensors for authentication.

2. The method of claim 1, wherein determining satisfaction of the liveness criteria based on sensor data captured by the one or more sensors of the device includes detecting a touch gesture, hand gesture, squeeze gesture, voice, face, blood pressure (BP), button activation, or combinations thereof.

3. The method of claim 1, further comprising:
providing, by the control system, user instructions requesting the biometric data based at least in part on the operation parameters specified by the authentication criteria.

4. The method of claim 3, wherein the user instructions provide an order in which the one or more biometric sensors should be activated, an amount of force to be applied to the one or more biometric sensors, an amount of time the one or more biometric sensors should be activated, or combinations thereof.

5. The method of claim 1, wherein the operation parameters specified by the authentication criteria require user authentication using a first fingerprint sensor of the device, a second fingerprint sensor of the device, a third fingerprint sensor of the device, an iris sensor, or combinations thereof.

6. The method of claim 5, wherein at least two of the first fingerprint sensor, the second fingerprint sensor, and the third fingerprint sensor are connected to a same controller of the device.

7. The method of claim 5, wherein the operation parameters specified by the authentication criteria require simultaneous operation of at least two of the first fingerprint sensor of the device, the second fingerprint sensor of the device, or the third fingerprint sensor of the device during the user authentication.

8. The method of claim 5, wherein the operation parameters specified by the authentication criteria define a sequential order for operating at least two of the first fingerprint sensor of the device, the second fingerprint sensor of the device, or the third fingerprint sensor of the device during the user authentication.

9. The method of claim 5, wherein the operation parameters specified by the authentication criteria define an amount of finger force to be applied when operating at least one of the first fingerprint sensor of the device, the second fingerprint sensor of the device, or the third fingerprint sensor of the device during the user authentication.

10. The method of claim 5, wherein the operation parameters specified by the authentication criteria define an amount of time a finger should be placed on at least one of the first fingerprint sensor of the device, the second fingerprint sensor of the device, or the third fingerprint sensor of the device during the user authentication.

11. An apparatus, comprising:
a control system configured to:
determine an authentication rule to authenticate a user of the apparatus, wherein the authentication rule includes liveness criteria and authentication criteria;
determine satisfaction of the liveness criteria based on sensor data captured by one or more sensors of the apparatus;
determine user interaction with one or more biometric sensors of the apparatus in accordance with operation parameters specified by the authentication criteria; and
based on the user interaction in accordance with the operation parameters specified by the authentication criteria, provide biometric data obtained from the one or more biometric sensors for authentication.

12. The apparatus of claim 11, wherein determining satisfaction of the liveness criteria based on sensor data captured by the one or more sensors of the apparatus includes detecting a touch gesture, hand gesture, squeeze gesture, voice, face, blood pressure (BP), button activation, or combinations thereof.

13. The apparatus of claim 11, wherein the control system is configured to:
provide user instructions requesting the biometric data based at least in part on the operation parameters specified by the authentication criteria.

14. The apparatus of claim 13, wherein the user instructions provide an order in which the one or more biometric sensors should be activated, an amount of force to be applied to the one or more biometric sensors, an amount of time the one or more biometric sensors should be activated, or combinations thereof.

15. The apparatus of claim 11, wherein the operation parameters specified by the authentication criteria require user authentication using a first fingerprint sensor of the device, a second fingerprint sensor of the device, a third fingerprint sensor of the device, an iris sensor, or combinations thereof.

16. One or more non-transitory computer-readable media having instructions for performing a method stored thereon, the method comprising:
determining, by a control system, an authentication rule to authenticate a user of a device, wherein the authentication rule includes liveness criteria and authentication criteria;
determining, by the control system, satisfaction of the liveness criteria based on sensor data captured by one or more sensors of the device;
determining, by the control system, user interaction with one or more biometric sensors of the device in accordance with operation parameters specified by the authentication criteria; and
based on the user interaction in accordance with the operation parameters specified by the authentication criteria, providing, by the control system, biometric data obtained from the one or more biometric sensors for authentication.

17. The one or more non-transitory computer-readable media of claim 16, wherein determining satisfaction of the liveness criteria based on sensor data captured by the one or more sensors of the device includes detecting a touch gesture, hand gesture, squeeze gesture, voice, face, blood pressure (BP), button activation, or combinations thereof.

18. The one or more non-transitory computer-readable media of claim 16, further comprising:
providing, by the control system, user instructions requesting the biometric data based at least in part on the operation parameters specified by the authentication criteria.

19. The one or more non-transitory computer-readable media of claim 18, wherein the user instructions provide an order in which the one or more biometric sensors should be activated, an amount of force to be applied to the one or more biometric sensors, an amount of time the one or more biometric sensors should be activated, or combinations thereof.

20. The one or more non-transitory computer-readable media of claim 16, wherein the operation parameters specified by the authentication criteria require user authentication using a first fingerprint sensor of the device, a second fingerprint sensor of the device, a third fingerprint sensor of the device, an iris sensor, or combinations thereof.
